(19) United States
(12) Patent Application Publication
(10) Pub. No.: US 2021/0350417 A1
(43) Pub. Date: Nov. 11, 2021

(54) RESOURCE PRESENTATION METHOD, RESOURCE PRESENTATION APPARATUS, AND STORAGE MEDIUM

(71) Applicant: BOE Technology Group Co., Ltd., Beijing (CN)

(72) Inventors: Ran Wang, Beijing (CN); Ning Jia, Beijing (CN)

(21) Appl. No.: 17/277,551

(22) PCT Filed: Jun. 9, 2020
(86) PCT No.: PCT/CN2020/095107

§ 371 Date: Mar. 18, 2021

(30) Foreign Application Priority Data
Jun. 19, 2019 (CN) 201910535305.5

(51) Int. Cl. G06Q 30/02; G06K 9/00; G06F 3/0488; G06N 3/08

(52) U.S. Cl. CPC G06Q 30/0271; G06Q 30/0272; G06K 2009/00322; G06F 3/0488; G06N 3/08; G06K 9/00288

(57) ABSTRACT

The present disclosure provides a resource presentation method, a resource presentation apparatus and a storage medium. The method includes: acquiring (320) image data for a selected time period, wherein the image data contains at least one human object; determining (340) whether the image data contains at least one target human object; selecting (360) at least one target resource from a resource list based on a characteristic attribute of the human object or the target human object; controlling (380) a presentation mode for presenting the target resource based on a result of determining whether the image data contains at least one target human object.

### CROSS-REFERENCE TO RELATED APPLICATION

This application is a Section 371 National Stage Application of International Application No. PCT/CN2020/095107, filed on Jul. 9, 2020, entitled “RESOURCE PRESENTATION METHOD, RESOURCE PRESENTATION APPARATUS, AND STORAGE MEDIUM”, which claims priority to Chinese Patent Application No. CN201910535305.5, filed on Jun. 19, 2019, which are incorporated herein by reference in their entirety.

### TECHNICAL FIELD

The present disclosure generally relates to the field of display technology, and in particular to a resource presentation method, a resource presentation apparatus, and a storage medium.

### BACKGROUND

With the development and expansion of e-commerce, a competition of online and offline product sales has gradually increased offline operating costs, resulting in a reduction in the profit margin of offline products. In order to improve the competitiveness of offline products and reduce operating costs, digital signs are placed in commercial areas to provide product advertisements to consumers.

At present, when a digital signage apparatus is used for advertising products, advertisement are mainly pushed in a single-mode, i.e. played in a preset mode.

In the single-mode advertising in which the advertising content is played in a single mode, consumers near the digital signage apparatus passively receive advertising content, resulting in poor interactivity and experience and unsatisfied effects in operation.

### SUMMARY

According to a first aspect of the embodiments of the present disclosure, there is provided a resource presentation method, including: acquiring image data for a selected time period, wherein the image data contains at least one human object; determining whether the image data contains at least one target human object; selecting at least one target resource from a resource list based on a characteristic attribute of the human object or the target human object; and controlling a presentation mode for presenting the target resource based on a result of determining whether the image data contains at least one target human object.

In the embodiments, the determining whether the image data contains at least one target human object includes: determining whether the image data contains at least one target human object staying for a duration greater than or equal to a threshold value; statistically analyzing the characteristic attribute of the human object in the image data, if the image data does not contain the at least one target human object staying for a duration greater than or equal to the threshold value; and identifying a face frame size of the target human object from the image data by using a face recognition algorithm, selecting a unique final target human object based on the face frame size, and determining the characteristic attribute of the final target human object, if the image data contains the at least one target human object staying for a duration greater than or equal to the threshold value.

In the embodiments, the selecting at least one target resource from a resource list based on a characteristic attribute of the human object or the target human object includes: acquiring the characteristic attribute of the human object or the characteristic attribute of the target human object, wherein the characteristic attribute contains sex and age; and selecting at least one target resource matching the sex and the age from the resource list based on the sex and the age.

In the embodiments, the controlling a presentation mode for presenting the target resource based on a result of determining whether the image data contains at least one target human object includes: controlling to present the target resource in a display area in a loop mode if the image data does not contain the at least one target human object; and controlling to divide the display area into at least one display sub-area if the image data contains the at least one target human object, wherein each display sub-area is configured to present a target resource associated with the display sub-area.

In the embodiments, the controlling a presentation mode for presenting the target resource based on a result of determining whether the image data contains at least one target human object further includes: controlling to present a target resource corresponding to a touch command in the display area, in response to the touch command is input, wherein the touch command is configured to select any one of the at least one display sub-area.

In the embodiments, the method further includes: transmitting a resource request message to a server to request for a first resource list, wherein the first resource list includes at least one resource record, each resource record containing at least a download address and a download identifier; and receiving the first resource list.

In the embodiments, the method further includes: determining whether the first resource list is the same as a second resource list stored locally; determining whether each resource record in the second resource list contains a first download identifier, in response to determining that the first resource list is the same as the second resource list, wherein the first download identifier indicates that a resource has been downloaded; keeping the second resource list non-updated, if each resource record contains a first download identifier; and acquiring a resource from the download address of the resource record, if the at least one resource record does not contain a first download identifier.

According to a second aspect of the embodiments of the present disclosure, there is provided a resource presentation apparatus, including: a display; and a processor coupled to the image acquisition device and the display, wherein the processor is configured to: acquire image data for a selected time period, wherein the image data contains at least one human object; determine whether the image data contains at least one target human object; select at least one target resource from a resource list based on a characteristic attribute of the human object or the target human object; and control a presentation mode for presenting the target resource based on a result of determining whether the image data contains at least one target human object, and control the display device to present the at least one target resource.

In the embodiments, the processor is further configured to: determine whether the image data contains the at least one target human object staying for a duration greater than or equal to a threshold value; statistically analyze the characteristic attribute of the human object in the image data if the image data does not contain the at least one target human object staying for a duration greater than or equal to the threshold value; and identify a face frame size of the target human object from the image data by using a face recognition algorithm, select a unique final target human object based on the face frame size, and determine the characteristic attribute of the final target human object, if the image data contains the at least one target human object staying for a duration greater than or equal to the threshold value.

In the embodiments, the processor is further configured to: acquire the characteristic attribute of the human object or the characteristic attribute of the target human object, wherein the characteristic attribute contains sex and age; and select at least one target resource matching the sex and the age from the resource list based on the sex and the age.

In the embodiments, the processor is further configured to: control to present the target resource in a display area in a loop mode if the image data does not contain the at least one target human object; and control to divide the display area into at least one display sub-area if the image data contains the at least one target human object, wherein each display sub-area is configured to display a target resource associated with the display sub-area.

In the embodiments, the resource presentation apparatus further includes a touch device coupled to the processor and configured to receive a touch command input by a user, and the processor is further configured to: control the display device to present a target resource corresponding to a touch command in the display area, in response to the touch command is input, wherein the touch command is configured to select any one of the at least one display sub-area.

In the embodiments, the resource presentation apparatus further includes a communication device coupled to the processor, and the processor is further configured to: transmit a resource request message through the communication device to a server to request for a first resource list, wherein the first resource list includes at least one resource record, each resource record containing at least a download address and a download identifier; and receive the first resource list from the server through the communication device.

In the embodiments, the processor is further configured to: determine whether the first resource list is the same as a second resource list stored locally; determine whether each resource record in the second resource list contains a first download identifier, in response to determining that the first resource list is the same as the second resource list, wherein the first download identifier indicates that a resource has been downloaded; keep the second resource list being non-updated, if each resource record contains a first download identifier; and acquire the resource from the download address of the resource record, if the at least one resource record does not contain a first download identifier.

In the embodiments, the apparatus further includes a camera coupled to the processor and configured to acquire the image data for the preset time period.

According to a third aspect of the embodiments of the present disclosure, there is provided a non-transitory computer-readable storage medium having a computer program stored thereon, wherein the computer program, when executed by a processor, causes the processor to perform any of the above methods.

### BRIEF DESCRIPTION OF THE DRAWINGS

By reading the detailed description of the non-limiting embodiments with reference to the following drawings, other features, objectives and advantages of the present disclosure will become more apparent.

FIG. 1 is a schematic diagram of a system including a resource presentation apparatus provided by an embodiment of the present disclosure.

FIG. 2 shows a schematic structural diagram of a resource presentation apparatus provided by an embodiment of the present disclosure.

FIG. 3 shows a schematic structural diagram of a resource presentation apparatus provided by another embodiment of the present disclosure.

FIG. 4 shows a schematic structural diagram of a resource presentation apparatus provided by an embodiment of the present disclosure.

FIG. 5 shows a schematic diagram of displaying a target advertisement according to an embodiment of the present disclosure.

FIG. 6 shows a schematic flowchart of a resource presentation method provided by an embodiment of the present disclosure.

FIG. 7 shows a schematic flowchart of a resource presentation method provided by another embodiment of the present disclosure.

FIG. 8 shows a schematic structural diagram of a computer system of an electronic apparatus according to an embodiment of the present disclosure.

### DETAILED DESCRIPTION OF EMBODIMENTS

The present disclosure will be further described in detail below with reference to the drawings and embodiments. It may be understood that the specific embodiments described here are only used to explain the related invention, but not to limit the present disclosure. In addition, it should be noted that, for ease of description, only the parts related to the present disclosure are shown in the drawings.

If advertisement content is simply presented in a loop in the resource presentation apparatus, there may be a problem that the resource presentation apparatus fails to capture an target human object who is interested in the advertisement content in a timely manner, resulting in failing to effectively adjust the resource presentation. Even if the resource presentation apparatus may capture the target human object who pays attention to the advertisement content, at present, it may only push relevant advertisement resources to a single target person, and the purchasing power of the target person is not considered, so that the efficiency of resource presentation is low. In addition, the simple loop mode of the resource presentation apparatus makes the target person's experience of the advertisement content not high.

Therefore, how to effectively improve the target person's experience of the resource presentation apparatus while improving the accuracy of resource presentation becomes a direction of improvement of the resource presentation apparatus. The embodiments of the present disclosure propose a resource presentation apparatus to effectively solve the above problem.

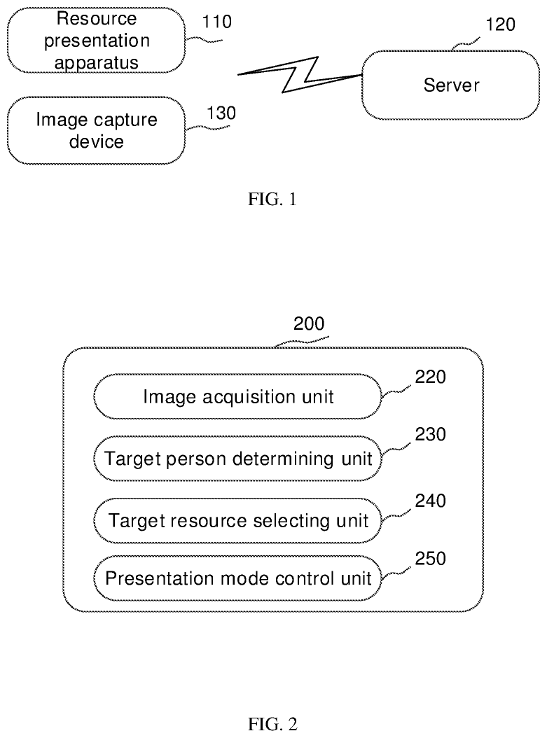

It should be noted that the embodiments in the present disclosure and the features in the embodiments may be combined with each other if they are not conflict. Hereinafter, the present disclosure will be described in detail with reference to FIGS. 1 to 4 in conjunction with the embodiments.

FIG. 1 shows a schematic diagram of a system including a resource presentation apparatus provided by an embodiment of the present disclosure. As shown in FIG. 1, the system may include at least one resource presentation apparatus 110 and a server 120.

In the embodiments of the present disclosure, the resource presentation apparatus 110 is used to present resources including advertisement resources. The resource presentation apparatus 110 may be a terminal apparatus for advertising, which may be referred as a digital signage apparatus. For example, it may be a display terminal apparatus in a digital signage system. The display terminal apparatus may be, for example, an LCD display. However, it is not limited to this, and any apparatus with a display function may be understood as the display terminal apparatus.

A media player may be pre-installed in the resource presentation apparatus. The media player may support multimedia such as video, audio, image. The video may include MPEG-1, MPEG-2, MPEG-4, DivX, Xvid, H.264, QuickTime, WMV, AVI, FLV, etc. The audio may include MP3, WAV, AC3, AIFF, etc. The image may include JPEG, GIF, PNG, TIFF, BMP, etc.

The server 120 may provide a resource list to the resource presentation apparatus 110. It may be a cloud server provided by a third party or a local server. The resource list may include a play task and a play file. The play file may include one or more media files. The media file may be AVI, Flash video, QuickTime MOV, Microsoft WMV, DivX, Xvid, H.264, MPEG-1, MPEG-2 and MPEG-4, etc.

The server 120 may provide resource information in the form of a list to the resource presentation apparatus, so that the resource presentation apparatus acquires advertisement resources according to the list and plays the advertisement resources in the list that have been downloaded to the local in a specified manner. The specific manner may be, for example, the number of times of play and the sequence of insertion. It may also specify the position of the advertisement displayed on the screen of the display, such as displaying the advertisement on full screen, on top and bottom parts of the screen, or on left and right parts of the screen, etc.

The server 120 may assign different authorities for managing functional modules to different resource presentation apparatuses, allowing different players and different program play authorities to be assigned to different resource presentation apparatuses.

The system may further include an image capture device 130, which may be a wide-angle camera configured to capture human object(s) passing by the resource presentation apparatus. A human object may include a person falling within any one of different age ranges. The image capture device 130 may be integrated with the resource presentation apparatus, or may be arranged outside the resource presentation apparatus.

The resource presentation apparatus 110 may transmit a resource request message to the server 120 every day at preset time(s), so as to acquire advertisement resource information from the server 120. The resource request message may be, for example, a GET request. After the advertising resource is acquired, the resource presentation apparatus 110 presents, e.g. displays, the advertising resource.

In the embodiments of the present disclosure, the resource presentation apparatus intelligently adjusts the resource based on the image data captured by the image capture device in order to attract users passing by the resource presentation apparatus, thereby improving the accuracy of advertising the resource, and providing the users with a friendly display interface while advertising the resource accurately in order to enhance the user experience of the resource presentation apparatus. To further understand the embodiments of the present disclosure, a detailed description will be given below with reference to the contents shown in FIGS. 2-7.

FIG. 2 shows a schematic structural diagram of a resource presentation apparatus provided by an embodiment of the present disclosure. As shown in FIG. 2, the resource presentation apparatus includes the following units.

An image acquisition unit 220 may acquire image data for a selected time period. The image data includes at least one human object.

The image data may be acquired by the image capture device 130 within the selected time period. For example, a wide-angle camera is used to capture image data of a crowd passing by the resource presentation apparatus. The image data may be stored in a storage device built in the image capture device 130 or other storage devices. The image acquisition unit 220 may acquire the image data from a corresponding storage device, so as to provide the image data to other functional units for analysis and processing. In the embodiments, the selected time period may be preset, manually adjusted or automatically adjusted. However, this embodiment is not limited to this.

A target person determining unit 230 may determine whether the image data contains at least one target human object.

After the image data is acquired, it is analyzed whether a target human object exists in the image data or not, so as to determine a processing mode of the image data. For example, it may be determined whether at least one target human object staying for a duration greater than or equal to a threshold value exists in the image data or not. The duration may be understood as a time period during which the target person stays in front of the resource presentation apparatus, which may have a length of, for example, 30 seconds, and the length may be adjusted and set as desired.

The target person determining unit 230 may further: determine whether the image data contains at least one target human object staying for a duration greater than or equal to the threshold value; statistically analyze the characteristic attribute of the human object in the image data if the image data does not contain the at least one target human object staying for a duration greater than or equal to the threshold value; and identify a face frame size of the target human object from the image data by using a face recognition algorithm, select a unique final target human object based on the face frame size, and determine the characteristic attribute of the final target human object, if the image data contains the at least one target human object staying for a duration greater than or equal to the threshold value.

The determining of whether the image data contains at least one target human object staying for duration greater than or equal to the threshold value may be performed, for example, according to a target tracking algorithm. The threshold value may be, for example, 1 minute or 30 seconds or 10 seconds, which may be adjusted as required by advertising.

If there is no target person staying for a duration which meets the threshold value, the target person determining unit 230 may trigger a statistical analysis of the characteristic attributes of the human object appearing in the image data, i.e. statistical analysis is performed on the human object appearing in the selected time period. For example, the selected time period is preset to have a length of 5 minutes or other value, which may be adjusted and set as desired. The image data captured during the selected time is analyzed, and the human object in the image data may be identified by using a neural network. For example, a face attribute, such as an age, a sex and the like may be identified through FasterR-CNN's face detection method.

Then, a result of the face detection is classified and counted according to age and sex to obtain a statistical result. The statistical result is used as the characteristic attribute of the human object appearing in the selected time period. The characteristic attribute may be used to characterize the user's purchasing power.

For example, by performing analysis periodically for a period of 5 minutes, it is determined that the number of males is X and the number of females is Y. Age ranges are set as follows: under 20 years old, 20-25 years old, 25-30 years old, 30-35 years old, 35-40 years old, 40-45 years old, 45-50 years old, 50-55 years old, 55-60 years old, and over 60 years old. The number of males and females in each age range is N, which may also be called range number.

In the embodiments of the present disclosure, considering male(s) in each age range have different purchasing power as compared to female(s) in the same age segment, different weights are assigned to different age ranges according to sex. Q_{M} represents the purchasing power of males in each age range, and Q_{F} represents the purchasing power of females in each age range. Weights Q_{M}, Q_{F} assigned by sex and age may be shown in Table 1 below.

TABLE 1

| Age range | <20 | 20-25 | 25-30 | 30-35 | 35-40 | 40-45 | 45-50 | 50-55 | 55-60 | >60 |
|---|---|---|---|---|---|---|---|---|---|---|
| Weight of | 0.9 | 1.5 | 1.2 | 1.1 | 1.7 | 1.0 | 0.8 | 0.6 | 0.5 | 0.3 |
| males Q_{M} | | | | | | | | | | |
| Weight of | 1.3 | 1.7 | 1.6 | 1.8 | 1.5 | 1.1 | 1.0 | 0.8 | 0.7 | 0.5 |
| females Q_{F} | | | | | | | | | | |

In the embodiments of the present disclosure, the relationship between the number X of males and the number Y of females appearing in the image data may be determined. For example, when the number of males is greater than the number of females, weight Q_{M} is used to calculate a purchasing power value of a corresponding age range. Then, the target resource suitable for the age range is selected as the content to be displayed in the next period, according to the purchasing power value from the target resource list. In contrast, when the number of males is less than the number of females, weight Q_{F} is used to calculate a purchasing power value of a corresponding age range.

Assuming that the person data collected from the image data indicates that there are 1 female under 20 years old, 2 males and 3 females of 25-30 years old, and 1 male of 35-40 years old, then the number of males is 3 and the number of females is 4. The number of females is greater than the number of males, and purchasing power values of corresponding female age ranges are 1.3*1, 1.6*3, and 0. Then the females aged 25-30 have potential purchasing power.

Additionally, if a target human object staying for a duration greater than or equal to a threshold value appears in the image data, a face recognition algorithm is used to identify a face frame size of the target human object staying for a duration greater than or equal to the threshold value from the image data. A unique final target human object is selected based on the face frame size, and the characteristic attribute of the final target human object is determined.

In the face recognition algorithm, the number of persons to be captured may be set to M, to obtain the information of M persons in the image data, including the face frame sizes of the persons. Considering that a user staying in front of the resource presentation apparatus for a duration greater than or equal to the threshold value may be more interested to the resource presentation content, further recommending an advertisement resource matched to the user may effectively improve the accuracy of advertising, so as to improve the efficiency of resource presentation.

When there is only one target human object staying in front of the resource presentation apparatus for a duration greater than or equal to the threshold value, the advertisement may be selected according to the age range of the target person.

When there are plurality of target human objects staying in front of the resource presentation apparatus for a duration greater than or equal to the threshold value, a target human object is used as the final target human object for advertisement placement, in order to capture the target human object more accurately. For example, when the resource presentation apparatus is placed in a public area and multiple persons are waiting for an elevator at the same time, users with different distances from the resource presentation apparatus may have different levels of interest to the advertising content. The resource presentation apparatus may select the user closer thereto as the target person.

For example, assuming that the face frame size detected from the image data is L, and the distance of the target person from the image capture device (such as a wide-angle camera) is S. The face frame size L is inversely proportional to the distance S, that is, L increases as S decreases, or L decreases as S increases.

In the embodiments of the present disclosure, a unique final target human object may be selected from a plurality of target human objects to be the advertising target, based on the relationship between a preset optimal distance S′ and a corresponding optimal face frame size L′.

Assuming that the optimal distance S′ and the corresponding optimal face frame size L′ are respectively taken as:

S′=1 meter, L′=250; and

S′=2 meters, L′=125.

The face frame size in the image data obtained by the face recognition algorithm is L. If L is greater than or equal to L′, it is determined that the target person corresponding to the face frame size is the target person meeting the selection conditions. For example, it is first determined whether L is greater than or equal to 125. And if not, it is determined whether L is less than or equal to 250. If yes, it is determined that the target person corresponding to the face frame size is the target person meeting the selection conditions, and if not, the target human object is ignored.

If L is greater than or equal to L′, the human object is selected as the target human object according to the following conditions.

When there is one human object has L greater than or equal to L′, the human object is determined as the only target human object.

When there are more than one human objects having L greater than or equal to L′, the human object with the largest L value is taken as the only target human object.

When there are a plurality of human objects having L greater than or equal to L′, with more than one of the users having the same greatest L value, one of the more than one of the users may be randomly selected as the only target human object.

A target resource selecting unit 240 may select at least one target resource from the resource list based on the characteristic attribute of the human object or that of the target human object.

After analyzing the image data to determine whether there is a target human object, a resource suitable to be pushed to the target person is selected from the target resource list based on the characteristic attribute of the target human object. If there is no target human object, the persons determined by the target person determining unit statistically is considered as the advertising target, and at least one target resource matching the sex and the age of the persons determined by the target person determining unit statistically may be selected from the target resource list.

If there is a target human object, a target resource is selected from the target resource list according to the sex and the age corresponding to the target human object.

It may be understood that when the target resource is selected based on the characteristic attributes including age and sex, the characteristic attributes may be pre-categorized (as shown in the following table), and each category may be associated with the target resource list, so that the target resource may be obtained by using the association relationship after the determination of the characteristic attribute of the current target human object.

A presentation mode control unit 250 may control a presentation mode for presenting the target resource based on a result of the determination of the target person determining unit 230.

After the target resource selecting unit 240 selects at least one target resource from the target resource list, the presentation mode for presenting the target resource may be controlled.

For example, if the image data does not contain at least one target human object, the target resource is presented in the display area in a loop mode. A plurality of suitable target resource contents are selected by using the statistical results of the human objects appearing in the image data as the characteristic attributes, and then displayed by the resource presentation apparatus in a loop mode.

For another example, if the image data contains at least one target human object, the display area is divided into at least one display sub-area. Each display sub-area is used to present a target resource associated with the display sub-area.

In response to a touch command is input, a target resource corresponding to the touch command may be presented in the display area. The touch command is used to select any one of the at least one display sub-area.

After the target human object is determined, the target resource matching the target human object is acquired from the target resource list and presented in the display area in form of thumbnails. The specific display position may be preset or dynamically set according to the face frame size of the target human object.

For example, the display area is divided into at least one display sub-area. The display sub-area may be used to present the target resource associated with the display sub-area. The user may select any one of the display sub-areas to click as desired, such that the touch command is input. After receiving the touch command input in the display sub-area, the target resource associated therewith is presented in the display area in response to the touch command In the embodiments, the touch device and the display device may be an integrated in an integral structure, such as a display with a touch function. Alternatively, the touch device and the display device may be separately provided.

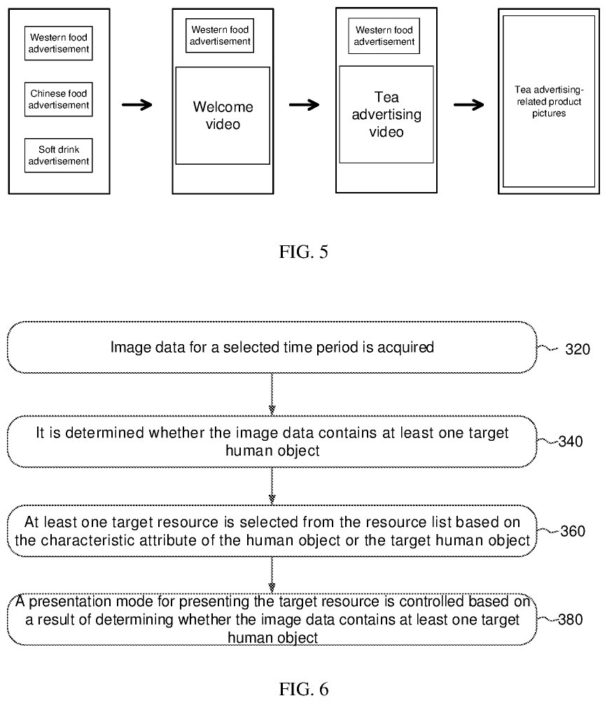

Additionally, a part of the display area may also be highlighted to present a welcome content. The welcome content may be selected according to the sex of the target person. Other conditions, such as the age, a combination of the sex and the age, or the expression of the target person, may also be used as the selection condition of the welcome content. After the playing of the welcome content is completed, it automatically switches back to the display area, and a plurality of static images of advertising content are presented in the display area. FIG. 5 shows a schematic diagram of displaying a target advertisement. As shown in FIG. 5, a plurality of display sub-areas may be present in the display area to present different advertising contents respectively. The welcome video may be displayed in the welcome video area. After the welcome video ends, the target advertisement corresponding to the touch command in the display sub-area is presented in the display area in response to the user's touch command.

Additionally, the display area may also support sliding upwards, downwards, leftwards and rightwards, so as to facilitate a user to browse other pages of advertisement details.

Additionally, a pop-up window with a size of 1080×240 may be popup at a position 2/3 the screen to present the advertisement, by using a welcome video function.

Additionally, if the target person walks away from the resource presentation apparatus and no image data meeting the requirements is captured by the image capture device within a period of time, the resource presentation apparatus will automatically return to the carousel interface, which is used to present advertising resources corresponding to the situation in which there is no target human objects.

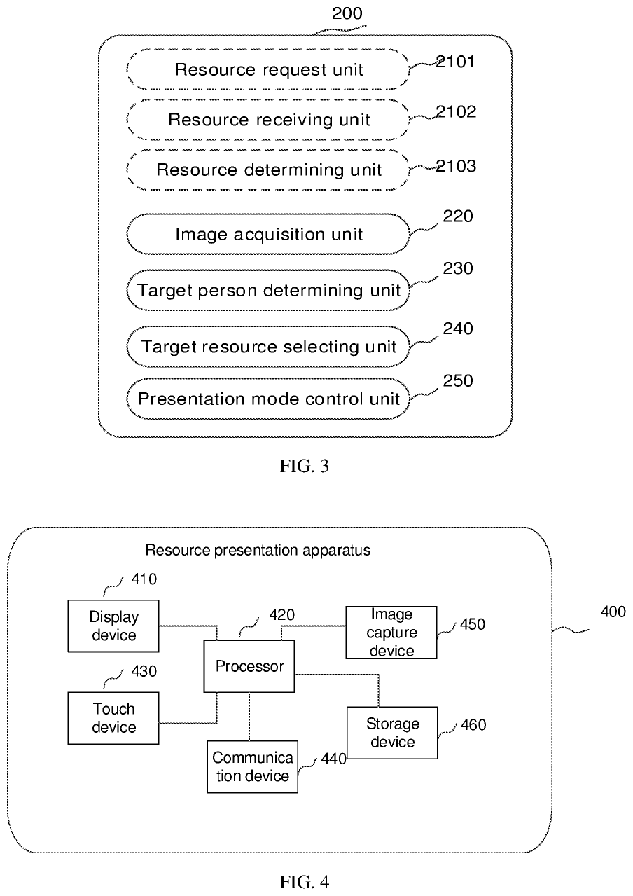

FIG. 3 shows a schematic structural diagram of a resource presentation apparatus provided by another embodiment of the present disclosure. As shown in FIG. 3, the resource presentation apparatus further includes a resource request unit 2101, a resource receiving unit 2102 and a resource determining unit 2103 in addition to the units shown in FIG. 2.

The resource request unit 2101 may transmit a resource request message to the server. The resource request message is used to request for a first target resource list. The first target resource list includes at least one resource record, each resource record containing a download address and a download identifier. The download address includes at least one associated FTP address, and the download identifier indicates whether the resource has been downloaded.

The resource receiving unit 2102 may receive the first resource list.

The resource list may be received from the server 120. The resource list may also be understood as a play task list, which may be, for example, implemented as follows.

<task

taskID = 1
taskName = file1.png
taskLink = ftp://192.168.1.2/download/file1.png
taskSex = “man”
taskAgeMax = “25”
taskAgeMin = “20”

</task>

where taskID is an ID of the play task, taskName is a name of the file to be played by the play task, taskLink is an address of the file to be played on the FTP server, from which the file to be played may be downloaded, taskSex is the sex of the group of persons to whom the file is to be presented, taskAgeMax is the maximum of the age ranges of the group of persons to whom the file is to be presented, and taskAgeMin is the minimum of the age ranges of the group of persons to whom the file is to be presented.

The resource determining unit 2103 may determine whether the first resource list is the same as a second resource list. If they are the same, it is determined whether each resource record in the second resource list contains a first download identifier for indicating that the resource has been downloaded.

If each resource record contains the first download identifier, the second resource list is not updated.

If there is at least one resource record that does not contain the first download identifier, a resource is acquired from the download address of the at least one resource record. The second resource list is a resource list stored locally.

After the latest first resource list transmitted by the server is received, it is first compared with the second resource list currently stored locally, so as to update the second resource list. A list name or task name of the first resource list may be compared with that of the second resource list. If they are the same, it is further determined whether each resource record in the second resource list contains a download identifier for indicating that the resource has been downloaded. For ease of understanding, the download identifier is referred to as a first download identifier. For example, a second download identifier may also be defined to indicate that the resource has not been downloaded. If each resource record contains the first download identifier, there is no need to update and download the resources corresponding to the second resource list, thereby saving download resources and reducing the cost of resource presentation.

If the first resource list is different from the second resource list, the second resource list is updated by using the first resource list.

If at least one resource is displayed as not being downloaded, it is requested to download the resource from the download server according to the download address corresponding to the download identifier so as to acquire the resource.

The resource presentation apparatus provided by the embodiments of the present disclosure extracts the target human object through intelligent processing of image data, selects the target advertisement that is suitable for the target human object according to the characteristic attribute of the target human object, and presents the target advertisement on the resource presentation apparatus, which enriches the placement model while achieving accurate advertising, thereby improving the efficiency of resource presentation.

FIG. 4 shows a schematic structural diagram of a resource presentation apparatus provided by an embodiment of the present disclosure. As shown in FIG. 4, a resource presentation apparatus 400 may include a display device 410 and a processor 420 coupled to the display device 410.

The processor 420 may acquire the image data for the selected time period, wherein the image data contains at least one human object; determine whether the image data contains at least one target human object; select at least one target resource from the resource list based on the characteristic attribute of the human object or the target human object; and control a presentation mode for presenting the target resource based on a result of determining whether the image data contains at least one target human object, and control the display device 410 to display the at least one target resource.

In the embodiments, the processor 420 may determine whether the image data contains at least one target human object staying for a duration greater than or equal to a threshold value; statistically analyze the characteristic attribute of the human object in the image data if the image data does not contain the at least one target human object staying for a duration greater than or equal to the threshold value; identify a face frame size of the target human object from the image data by using a face recognition algorithm, select a unique final target human object based on the face frame size, and determine the characteristic attribute of the final target human object, if the image data contains the at least one target human object staying for a duration greater than or equal to the threshold value.

In the embodiments, the processor 420 may acquire the characteristic attribute of the human object or the characteristic attribute of the target human object, wherein the characteristic attribute contains a sex and an age; select at least one target resource matching the sex and age from the resource list based on the sex and the age.

In the embodiments, the processor 420 may control the display device to present the target resource in a display area in a loop mode if the image data does not contain the at least one target human object; and control the display device to divide the display area into at least one display sub-area if the image data contains the at least one target human object, wherein each display sub-area is configured to display a target resource associated with the display sub-area.

The resource presentation apparatus 400 further includes a touch device 430 configured to receive a touch command input by a user. The touch device 430 is coupled to the processor. In the embodiments, the processor 420 controls the display device to present a target resource corresponding to a touch command in the display area, in response to the input of the touch command wherein the touch command is used to select any one of the at least one display sub-area.

The resource presentation apparatus 400 further includes a communication device 440 coupled to the processor. In the embodiments, the processor 420 may transmit a resource request message to a server to request for a first resource list and receive the first resource list from the server through the communication device, wherein the first resource list includes at least one resource record, with each resource containing at least a download address and a download identifier.

In the embodiments, the processor 420 may determine whether the first resource list is the same as a second resource list stored locally; determine whether each resource record in the second resource list contains a first download identifier or not, in response to determining that the first resource list is the same as the second resource list, wherein the first download identifier indicates that a resource has been downloaded; keep the second resource list being non-updated in response to determining that each resource record contains the first download identifier; acquire the resource, in response to determining that at least one resource record does not contain the first download identifier, from the download address of the resource record.

The resource presentation apparatus 400 may further include an image capture device 450 configured to capture image data for a selected time period. The image data contains at least one target human object.

The image capture device 450 may capture image data of a target person passing by or staying in front of the resource presentation apparatus 400 during the selected time period, and analyze the image data by using a stored program, so as to control the advertising.

The resource presentation apparatus 400 may further include a storage device 460 for storing the advertising resource that the resource presentation apparatus 400 has acquired.

The embodiments of the present disclosure further provide a resource presentation method. FIG. 6 shows a schematic flowchart of a resource presentation method provided by an embodiment of the present disclosure. As shown in FIG. 6, the method includes following steps.

In step 320, image data for a selected time period is acquired. The image data contains at least one human object.

In step 340, it is determined whether the image data contains at least one target human object.

In step 360, at least one target resource is selected from the resource list based on the characteristic attribute of the human object or the target human object.

In step 380, a presentation mode for presenting the target resource is controlled based on a result of determining whether the image data contains at least one target human object.

In the embodiments of the present disclosure, after the image data is acquired, the target human object contained in the image data is analyzed to determine the processing mode of the image data. For example, it may be determined whether the image data contains at least one target human object staying for a duration greater than or equal to a threshold value. The duration of staying may be understood as a time period during which the target person stays in front of the resource presentation apparatus.

The determining whether the image data contains at least one target human object includes steps of: determining whether the image data contains at least one target human object staying for a duration greater than or equal to a threshold value; statistically analyzing the characteristic attribute of the human object in the image data if the image data does not contain the at least one target human object staying for a duration greater than or equal to the threshold value; identifying a face frame size of the target human object from the image data by using a face recognition algorithm, selecting a unique final target human object based on the face frame size, and determining the characteristic attribute of the final target human object, if the image data contains the at least one target human object staying for duration greater than or equal to the threshold value.

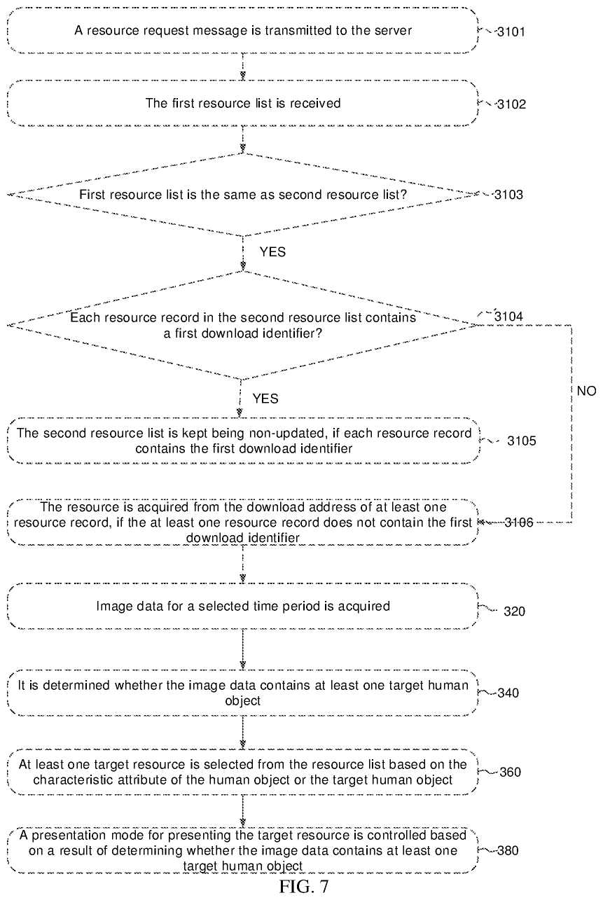

Additionally, the resource presentation may also be achieved by the method shown in FIG. 7. FIG. 7 shows a schematic flowchart of a resource presentation method provided by another embodiment of the present disclosure.

In step 3101, a resource request message is transmitted to the server to request for the first resource list. The first target resource list includes at least one resource record, with each resource record containing a download address and a download identifier. The download address contains at least one associated FTP address, and the download identifier indicates whether the resource has been downloaded.

In step 3102, the first resource list is received.

In step 3103, it is determined whether the first resource list is the same as the second resource list stored locally. If they are not the same, the first resource list is stored, the second resource list is updated with the first resource list, and the resources in the first resource list are downloaded one by one.

In step 3104, it is determined whether each resource record in the second resource list contains a first download identifier, in response to determining that the first resource list is the same as the second resource list. The first download identifier indicates that the resource has been downloaded.

In step 3105, the second resource list is kept being non-updated if each resource record contains a first download identifier.

In step 3106, the resource is acquired from download address of at least one resource record, if the at least one resource record does not contain a first download identifier.

The resource presentation apparatus provided by the embodiments of the present disclosure extracts the target human object through intelligent processing of image data, selects the target advertisement suitable for the target human object based on the characteristic attribute of the target human object, and presents the target advertisement on the resource presentation apparatus, which enriches the manners of advertising while achieving accurate advertising, thereby improving the efficiency of resource presentation.

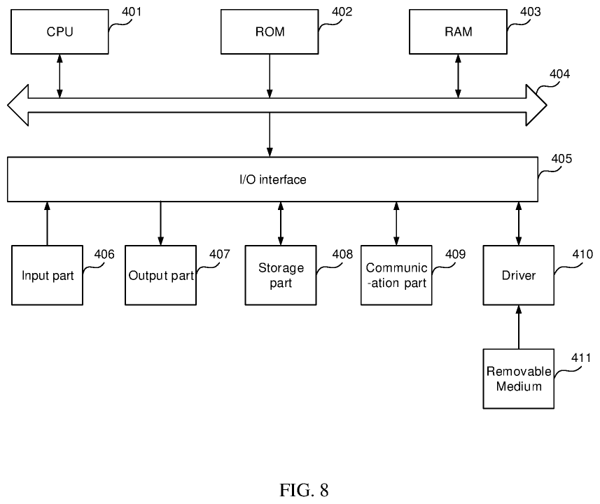

Next, referring to FIG. 8, it shows a schematic structural diagram of a computer system 400 suitable for implementing an electronic apparatus (such as the resource presentation apparatus) according to an embodiment of the present disclosure.

As shown in FIG. 8, the computer system 400 includes a central processing unit (CPU) 401, which may execute various appropriate actions and processing according to the program stored in a read only memory (ROM) 402 or the program loaded into a random access memory (RAM) 403 from a storage part 403. Various programs and data required for the operation of the system 400 are stored in the RAM 403. The CPU 401, the ROM 1202 and the RAM 403 are connected to each other through a bus 404. An input/output (I/O) interface 405 is also connected to the bus 404.

The following components are connected to the I/O interface 405: an input part 406 including a keyboard, a mouse, etc.; an output part 407 including a cathode ray tube (CRT), a liquid crystal display (LCD), etc. and a speaker, etc.; a storage part 408 including a hard disk, etc.; and a communication part 409 including a network interface card such as a LAN card, a modem, and the like. The communication part 409 performs communication processing via a network such as the Internet. A drive 410 is also connected to the I/O interface 905 as required. A removable medium 411, such as a magnetic disk, an optical disk, a magneto-optical disk, a semiconductor memory, and the like, is installed on the drive 410 as required, so that the computer program read therefrom is installed into the storage part 408 as needed.

In particular, according to the embodiments of the resource presentation disclosed in the present disclosure, the process described above with reference to FIG. 1 may be implemented as a computer software program. For example, the embodiments of the resource presentation disclosed in the present disclosure include a computer program product, which includes a computer program tangibly contained on a machine-readable medium. The computer program contains a program code for executing the method shown in FIG. 2 or FIG. 3. In such an embodiment, the computer program may be downloaded and installed from the network through the communication part 409, and/or installed from the removable medium 411.

It should be noted that the computer readable medium in the present disclosure may be a computer readable signal medium, a computer readable storage medium, or any combination thereof. The computer-readable storage medium may be, for example, but not limited to, an electric, magnetic, optical, electromagnetic, infrared or semiconductor system, apparatus or device, or any combination thereof. More specific examples of the computer-readable storage medium may include, but are not limited to: electrical connections with one or more wires, portable computer disks, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above. In the present disclosure, the computer-readable storage medium may be any tangible medium that includes or stores programs that may be used by or in combination with an instruction execution system, apparatus, or device.

In the present disclosure, the computer-readable signal medium may contain a data signal propagated in a baseband or as a part of a carrier wave, and a computer-readable program code is carried therein. This propagated data signal may take many forms, including but not limited to electromagnetic signals, optical signals, or any suitable combination of the above. The computer-readable signal medium may also be any computer-readable medium other than the computer-readable storage medium. The computer-readable medium may send, propagate, or transmit the program for use by or in combination with the instruction execution system, apparatus, or device. The program code contained on the computer-readable medium may be transmitted by any suitable medium, including but not limited to wireless, wired, optical cable, radio frequency signals, etc., or any suitable combination of the above.

The flowcharts and block diagrams in the drawings illustrate the possible architecture, functions and operations of the system, method and computer program product according to various embodiments of the present disclosure. In this regard, each block in the flowcharts or block diagrams may represent a part of a module, program segment, or code, which part includes one or more executable instructions for implementing the specified logical function. It should also be noted that, in some alternative implementations, the functions noted in the blocks may also occur in a different order than that noted in the accompanying drawings. For example, two blocks shown in succession may actually be executed substantially in parallel, or they may sometimes be executed in the reverse order, depending on the functions involved. It should also be noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

The units or modules involved in the embodiments described in the present disclosure may be implemented in software or hardware. The units or modules described may also be provided in the processor. For example, it may be described as: a processor includes a resource list receiving unit, an image data acquisition unit, a processing mode determining unit, a target resource selecting unit, and a presentation mode control unit. The names of these units or modules do not constitute a limitation on the units or modules under certain circumstances. For example, the first presentation mode control unit may also be described as “being configured to control a presentation mode for presenting the target resource based on the processing mode.”

According to another aspect, the present disclosure further provides a computer-readable storage medium. The computer-readable storage medium may be a computer-readable storage medium included in the above apparatus in the above-mentioned embodiments, or may be a computer-readable storage medium separately provided without being installed in the apparatus. The computer-readable storage medium stores one or more programs executable by one or more processors to perform the resource presentation method described in the present disclosure.

The above descriptions are only preferred embodiments of the present disclosure and explanations of the technical principles applied. Those skilled in the art should understand that the scope of the invention involved in the present disclosure is not limited to the technical solutions formed by the specific combination of the above technical features, and should also cover other technical solutions formed by any combination of the above technical features or their equivalent features without departing from the inventive concept, for example, the technical features formed by mutual replacements of the above-mentioned features and the technical features with similar functions disclosed in the present disclosure (but not limited thereto).

1. A resource presentation method, comprising:
acquiring image data for a selected time period, wherein the image data contains at least one human object;
determining whether the image data contains at least one target human object;
selecting at least one target resource from a resource list based on a characteristic attribute of the human object or the target human object; and
controlling a presentation mode for presenting the target resource based on a result of determining whether the image data contains at least one target human object.

2. The resource presentation method according to claim 1, wherein the determining whether the image data contains at least one target human object comprises:
determining whether the image data contains at least one target human object staying for a duration greater than or equal to a threshold value;
statistically analyzing the characteristic attribute of the human object in the image data, if the image data does not contain the at least one target human object staying for a duration greater than or equal to the threshold value; and
identifying a face frame size of the target human object from the image data by using a face recognition algorithm, selecting a unique final target human object based on the face frame size, and determining the characteristic attribute of the final target human object, if the image data contains the at least one target human object staying for a duration greater than or equal to the threshold value.

3. The resource presentation method according to claim 1, wherein the selecting at least one target resource from a resource list based on a characteristic attribute of the human object or that of the target human object comprises:
acquiring the characteristic attribute of the human object or the characteristic attribute of the target human object, wherein the characteristic attribute contains sex and age; and
selecting at least one target resource matching the sex and the age from the resource list based on the sex and the age.

4. The source display method according to claim 1, wherein the controlling a presentation mode for presenting the target resource based on a result of determining whether the image data contains at least one target human object comprises:
controlling to present the target resource in a display area in a loop mode if the image data does not contain the at least one target human object; and
controlling to divide the display area into at least one display sub-area if the image data contains the at least one target human object, wherein each display sub-area is configured to present a target resource associated with the each display sub-area.

5. The source display method according to claim 4, wherein the controlling a presentation mode for presenting the target resource based on a result of determining whether the image data contains at least one target human object comprises:
controlling to present a target resource corresponding to a touch command in the display area, in response to the touch command is input, wherein the touch command is configured to select any one of the at least one display sub-area.

6. The resource presentation method according to claim 1, further comprising:
transmitting a resource request message to a server to request for a first resource list, wherein the first resource list comprises at least one resource record, each resource record containing at least a download address and a download identifier; and
receiving the first resource list.

7. The resource presentation method according to claim 6, further comprising:
determining whether the first resource list is the same as a second resource list stored locally;
determining whether each resource record in the second resource list contains a first download identifier, in response to determining that the first resource list is the same as the second resource list, wherein the first download identifier indicates that a resource has been downloaded;
keeping the second resource list being non-updated, if the each resource record contains a first download identifier; and
acquiring a resource from download address of at least one resource record, if the at least one resource record does not contain a first download identifier.

8. A resource presentation apparatus, comprising:
a display; and
a processor coupled to the display, wherein the processor is configured to:
acquire image data for a selected time period, wherein the image data contains at least one human object;
determine whether the image data contains at least one target human object;
select at least one target resource from a resource list based on a characteristic attribute of the human object or the target human object; and
control a presentation mode for presenting the target resource based on a result of determining whether the image data contains at least one target human object, and control the display device to display the at least one target resource.

9. The resource presentation apparatus according to claim 8, wherein the processor is further configured to:
determine whether the image data contains at least one target human object staying for a duration greater than or equal to a threshold value;
statistically analyze the characteristic attribute of the human object in the image data if the image data does not contain the at least one target human object staying for a duration greater than or equal to the threshold value; and
identify a face frame size of the target human object from the image data by using a face recognition algorithm, select a unique final target human object based on the face frame size, and determine the characteristic attribute of the final target human object, if the image data contains the at least one target human object staying for a duration greater than or equal to the threshold value.

10. The resource presentation apparatus according to claim 8, wherein the processor is further configured to:
acquire the characteristic attribute of the human object or the characteristic attribute of the target human object, wherein the characteristic attribute contains sex and age; and
select at least one target resource matching the sex and the age from the resource list based on the sex and the age.

11. The resource presentation apparatus according to claim 8, wherein the processor is further configured to:
control the display device to present the target resource in a display area in a loop mode if the image data does not contain the at least one target human object; and
control the display device to divide the display area into at least one display sub-area if the image data contains the at least one target human object, wherein each display sub-area is configured to present a target resource associated with the display sub-area.

12. The resource presentation apparatus according to claim 11, further comprising a touch device coupled to the processor and configured to receive a touch command input by a user, wherein the processor is further configured to:
control the display device to display a target resource corresponding to a touch command in the display area, in response to the touch command is input, wherein the touch command is configured to select any one of the at least one display sub-area.

13. The resource presentation apparatus according to claim 8, further comprising a communication device coupled to the processor, wherein the processor is further configured to:
transmit a resource request message through the communication device to a server to request for a first resource list, wherein the first resource list comprises at least one resource record, each resource record containing at least a download address and a download identifier; and
receive the first resource list from the server through the communication device.

14. The resource presentation apparatus according to claim 13, wherein the processor is further configured to:
determine whether the first resource list is the same as a second resource list stored locally;
determine whether each resource record in the second resource list contains a first download identifier, in response to determining that the first resource list is the same as the second resource list, wherein the first download identifier indicates that a resource has been downloaded;
keep the second resource list being non-updated, if each resource record contains a first download identifier; and
acquire a resource from download address of at least one resource record, if the at least one resource record does not contain a first download identifier.

15. The resource presentation apparatus according to claim 8, further comprising:
a camera coupled to the processor and configured to acquire the image data for the selected time period.

16. A non-transitory computer-readable storage medium having a computer program stored thereon, wherein the computer program, when executed by a processor, causes the processor to perform the method according to claim 1.

17. A non-transitory computer-readable storage medium having a computer program stored thereon, wherein the computer program, when executed by a processor, causes the processor to perform the method according to claim 2.

18. A non-transitory computer-readable storage medium having a computer program stored thereon, wherein the computer program, when executed by a processor, causes the processor to perform the method according to claim 3.

19. A non-transitory computer-readable storage medium having a computer program stored thereon, wherein the computer program, when executed by a processor, causes the processor to perform the method according to claim 4.

20. A non-transitory computer-readable storage medium having a computer program stored thereon, wherein the computer program, when executed by a processor, causes the processor to perform the method according to claim 5.
